(19) United States
(12) Patent Application Publication
(10) Pub. No.: US 2010/0040111 A1
(43) Pub. Date: Feb. 18, 2010

(54) TEMPERATURE MEASURING METHOD AND TEMPERATURE MEASURING APPARATUS USING THE SAME

(75) Inventors: Ping-Pao Cheng, Hsinchu County (TW); Yen-Hung Chen, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/265,737

(22) Filed: Nov. 6, 2008

(30) Foreign Application Priority Data
Aug. 14, 2008 (TW) 97130975

(51) Int. Cl. G01K 7/00

(52) U.S. Cl. 374/170; 374/E07.001

(57) ABSTRACT

A temperature measuring method and a temperature measuring apparatus using the same are provided. In the method, four different currents are provided to a temperature measuring device respectively so as to obtain four different voltages at two ends of the temperature measuring apparatus correspondingly. A ratio of two of the four different currents is equal to a ratio of the other two currents. Next, two voltage variation values are obtained according to mentioned four different voltages. One of the voltage variation values is converted to a first digital temperature code representing a first temperature, and the other voltage variation value is converted to a second digital temperature code representing a second temperature. Then, a real temperature code representing a real temperature is obtained according to the first digital temperature code and the second digital temperature code.

### CROSS-REFERENCE TO RELATED APPLICATION

This application claims the priority benefit of Taiwan application serial no. 97130975, filed Aug. 14, 2008. The entirety of the above-mentioned patent application is hereby incorporated by reference herein and made a part of this specification.

### BACKGROUND OF THE INVENTION

1. Field of the Invention

The present invention relates to the field of temperature measuring, and particularly to a temperature measuring method and a temperature measuring apparatus using the same.

2. Description of Related Art

FIG. 1 is a conventional temperature measuring apparatus. Referring to FIG. 1, the apparatus includes current sources 110-130, switches 140-160, an NPN-type transistor 170 and an analog-to-digital conversion circuit 180. The temperature measuring apparatus provides different currents to the transistor 170 by switching the switches 140-160 to obtain different voltages Vin. The voltages Vin are converted into digital data through the analog-to-digital conversion circuit 180, and the digital data obtained through the analog-to-digital conversion circuit 180 are calculated to output a temperature data OUT. To facilitate explanation, an equivalent circuit of FIG. 1 is taken for example, as shown by FIG. 2.

Referring to FIG. 2, a transistor 170 in FIG. 1 is rendered equivalent to a resistance 172 and a diode 174. The diode 174 represents an equivalent diode constituted by a PN junction of a base-emitter of the transistor 170. The resistance 172 represents a parasitic serial resistance inside the transistor 170. During operation of the temperature measuring apparatus, the switch 150 is turned on solely first to provide a current 12 to the transistor 170 so that the analog-to-digital conversion circuit 180 obtains a voltage Vin. A value of the voltage Vin is expressed by a following formula (1):

$$\begin{matrix}Vin ( I 2 ) = Vbe + Verr \\ = ( η kT / q ) \times ln ( I 2 / Is ) + I 2 \times Rs\end{matrix} \qquad ( 1 )$$

η represents an ideality factor of the PN junction; k represents a Boltzman's constant. T represents an absolute temperature; q represents quantity of electronic charge; Is represents a saturation current of the diode 174, and Rs represents a value of the resistance 172.

Afterwards, the switch 160 is solely turned on to provide a current 13 to the transistor 170 so that the analog-to-digital conversion circuit 180 further obtains a voltage Vin. A value of the voltage Vin is expressed by a following formula (2):

Vin(I3)=(ηkT/q)×ln(I3/Is)+I3×Rs (2)

Then, the analog-to-digital conversion circuit 180 subtracts Vin(12) from Vin(13), i.e. Formula (2) minus Formula (1), to obtain a first voltage variation value of the voltage Vin. The first voltage variation value is expressed by a following formula (3):

$$\begin{matrix}Δ Vin ( i ) = Vin ( I 3 ) - Vin ( I 2 ) \\ = ( η kT / q ) \times ln ( I 3 / I 2 ) + ( I 3 - I 2 ) \times Rs\end{matrix} \qquad ( 3 )$$

Thereafter, the switch 140 is solely turned on to provide a current I1 to the transistor 170 so that the analog-to-digital conversion circuit 180 further obtains a voltage Vin. A value of the voltage Vin is expressed by a following formula (4):

Vin(I1)=(ηkT/q)×ln(I1/Is)+I1×Rs (4)

Then, the analog-to-digital conversion circuit 180 subtracts Vin(11) from Vin(I2), i.e. Formula (1) minus Formula (4), to obtain a second voltage variation value of the voltage Vin. The second voltage variation value is expressed by a following formula (5):

$$\begin{matrix}Δ Vin ( ii ) = Vin ( I 2 ) - Vin ( I 1 ) \\ = ( η kT / q ) \times ln ( I 2 / I 1 ) + ( I 2 - I 1 ) \times Rs\end{matrix} \qquad ( 5 )$$

Next, the analog-to-digital conversion circuit 180 subtracts the first voltage variation value from the second voltage variation value, i.e., Formula (5) minus Formula (3). A result is expressed by a following formula (6):

$$\begin{matrix}Δ Vin = Δ Vin ( ii ) - Δ Vin ( i ) \\ = ( η kT / q ) \times ln ( ( I 2 \times I 2 / ( I 1 \times I 3 ) ) + \\ ( 2 \times I 2 - I 1 - I 3 ) \times Rs\end{matrix} \qquad ( 6 )$$

From Formula (6), it is known that as long as the equation, (2×I2−I1−I3)=0, stands, an error in temperature measuring caused by Rs can be excluded. Certainly, (I2×I2)/(I1×I3) must be set as a constant N larger than 1, or (ηkT/q)×ln((I2×I2)/(I1×I3)) would be rendered as equal to zero. Once (2×I2−I1−I3)=0, and (I2×12)(I1×I3) is set as a constant N larger than 1, Formula (6) may be rewritten into a following formula (7):

ΔVin=(ηkT/q)×ln (N) (7)

Through Formula (7), a temperature T may be expressed by a following formula (8):

T=ΔVin×q/(ηk×ln(N)) (8)

In other words, the temperature T is in a positive proportion to ΔVin. Through the positive proportional relationship, the analog-to-digital conversion circuit 180 may convert said ΔVin into a digital temperature code to express the temperature T and serve as the temperature data OUT. For example, the analog-to-digital conversion circuit 180 may employ a method expressed by a following formula (9) to convert ΔVin:

Voltage variation value=K×Temperature (9)

K is a conversion rate of the voltage variation value to temperature of the analog-to-digital conversion circuit 180.

However, this technique has one disadvantage, which is explained by Formula (6) as follows:

$$\begin{matrix}Δ Vin = Δ Vin ( ii ) - Δ Vin ( i ) \\ = ( η kT / q ) \times ln ( ( I 2 \times I 2 / ( I 1 \times I 3 ) ) + \\ ( 2 \times I 2 - I 1 - I 3 ) \times Rs\end{matrix} \qquad ( 6 )$$

Although this technique can eliminate the error in temperature measuring caused by Rs under the condition (2×I2−II−I3)=0, with a limited maximum current among I1, I2 and I3 and due to (ηkT/q)×ln((I2×I2)/(I1×I3)), the value of ΔVin obtained after employing this technique is smaller than the value of ΔVin obtained before employing this technique. Consequently, the analog-to-digital conversion circuit 180 needs to employ a greater amplifying power to amplify ΔVin to convert ΔVin into a digital temperature code such that the error of ΔVin is also amplified and thereby resulting in an error in temperature measuring instead.

### SUMMARY OF THE INVENTION

The present invention provides a temperature measuring method, which does not need to employ a greater amplifying power to amplify a voltage variation value and thereby restraining errors in temperature measuring.

The present invention further provides a temperature measuring apparatus, which does not need to employ a greater amplifying power to amplify a voltage variation value and thereby restraining errors in temperature measuring.

The present invention provides a temperature measuring method. The temperature measuring method includes following steps. First, a first current, a second current, a third current, a fourth current are provided to a temperature measuring device to obtain a first voltage, a second voltage, a third voltage and a fourth voltage at two ends of the temperature measuring apparatus correspondingly. Afterwards, a first voltage variation value is obtained according to the first voltage and the second voltage, and a second voltage variation value is obtained according to the third voltage and the fourth voltage. Thereafter, the first voltage variation value is converted into a first digital temperature code, and the second voltage variation value is converted into a second digital temperature code. The first digital temperature code represents a first temperature, and the second digital temperature code represents a second temperature. Then, a real temperature code corresponding to a real temperature is obtained according to the first digital temperature code and the second digital temperature code.

The present invention further provides a temperature measuring apparatus including a temperature measuring device, a current supply circuit, and an analog-to-digital conversion circuit. The temperature measuring device has a first end and a second end. The current supply circuit is coupled to the first end of the temperature measuring device for providing the first current, the second current, the third current and the fourth current to the temperature measuring device. Intensities of the currents differ from one another, and a ratio of the first current to the second current is equal to a ratio of the third current to the fourth current. The analog-to-digital conversion circuit is coupled to the first end and the second end of the temperature measuring device for obtaining correspondingly the first voltage, the second voltage, the third voltage and the fourth voltage at two ends of the temperature measuring device when the current supply circuit provides the first current, the second current, the third current and the fourth current respectively. The analog-to-digital conversion circuit also obtains the first voltage variation value according to the first voltage and the second voltage, and obtains the second voltage variation value according to the third voltage and the fourth voltage. Moreover, the analog-to-digital conversion circuit converts the first voltage variation value into the first digital temperature code representing the first temperature, converts the second variation value into the second digital temperature code representing the second temperature, and obtains the real temperature code corresponding to the real temperature according to the first digital temperature code and the second digital temperature code.

According to a temperature measuring method and a temperature measuring apparatus in an embodiment of the present invention, the intensity of the first current is a first current value of a first multiple; the intensity of the second current is a second current value of the first multiple; the intensity of the third current is a first current value of a second multiple; the intensity of the fourth current is a second current value of the second multiple. The first current value is larger than the second current value; the first multiple is not equal to the second multiple, and the first multiple and the second multiple are both larger than zero.

According to a temperature measuring apparatus in an embodiment of the present invention, the temperature measuring device has an equivalent diode constituted by a PN junction and a parasitic serial resistance serially connected to the equivalent diode. The equivalent diode and the parasitic serial resistance are serially connected between the first end and the second end of the temperature measuring device.

According to a temperature measuring method and a temperature measuring apparatus in an embodiment of the present invention, the real temperature code is obtained by employing a temperature formula. The temperature formula is expressed as T=(C2×T1−C1×T2)/(C2−C1). T represents the real temperature; C2 represents the second multiple; T1 represents the first temperature; C1 represents the first multiple, and T2 represents the second temperature.

The present invention provides four different currents to a temperature measuring device respectively to obtain four different voltages at the two ends of the temperature measuring device correspondingly. Among the four currents, a ratio of two of the four currents is equal to a ratio of the other two currents. Next, two voltage variation values are obtained according to the two current sets with the same ratio and the four voltages, and the two voltage variation values are converted into a first digital temperature code and a second digital temperature code respectively. The first digital temperature code represents the first temperature, and the second digital temperature code represents the second temperature. Then, the real temperature code corresponding to the real temperature is obtained according to the first digital temperature code and the second digital temperature code. After obtaining the two voltage variation values, the two voltage variation values are converted into the first digital temperature code and the second digital temperature code respectively. Therefore, even if the voltage variation values need to be amplified to be converted into the digital temperature codes, the voltage variation values may appear larger by adjusting the current ratio beforehand. The voltage variation values no longer require a larger amplifying power to amplify the voltage variation values and thereby restraining errors in temperature measuring.

Furthermore, as long as the temperature measuring device has an equivalent diode and a parasitic serial resistance, and the equivalent diode and the parasitic serial resistance are serially connected between the first end and the second end of the temperature measuring device, the temperature formula expressed as T=(C2×T1−C1×T2)/(C2−C1) can be employed to obtain the real temperature code corresponding to the real temperature.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a conventional temperature measuring apparatus.

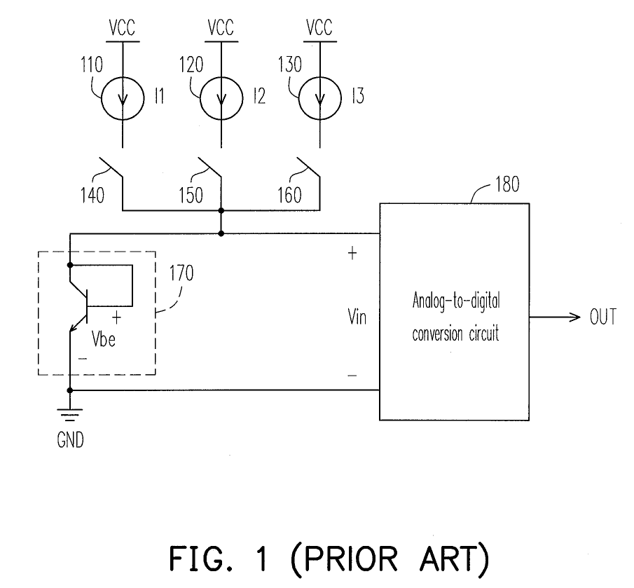

FIG. 2 is the equivalent circuit diagram of FIG. 1.

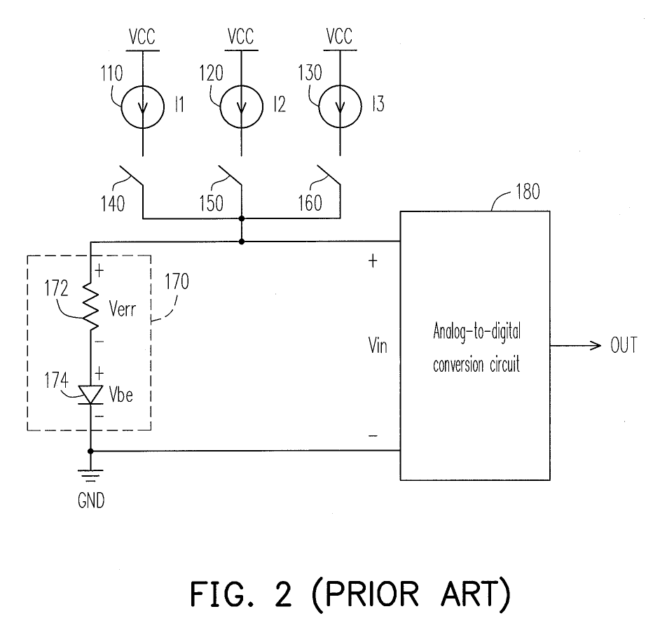

FIG. 3 shows a temperature measuring apparatus according to an embodiment of the present invention.

FIG. 4 is the equivalent circuit diagram of FIG. 3.

FIG. 5 shows a temperature measuring apparatus according to another embodiment of the present invention.

FIG. 6 shows a temperature measuring apparatus according to yet another embodiment of the present invention.

FIG. 7 shows a temperature measuring apparatus according to still another embodiment of the present invention.

FIG. 8 shows a temperature measuring apparatus according to still yet another embodiment of the present invention.

FIG. 9 shows the circuit of FIG. 3 having other resistances.

FIG. 10 is a flowchart of an temperature measuring method according to an embodiment of the present invention.

### DESCRIPTION OF EMBODIMENTS

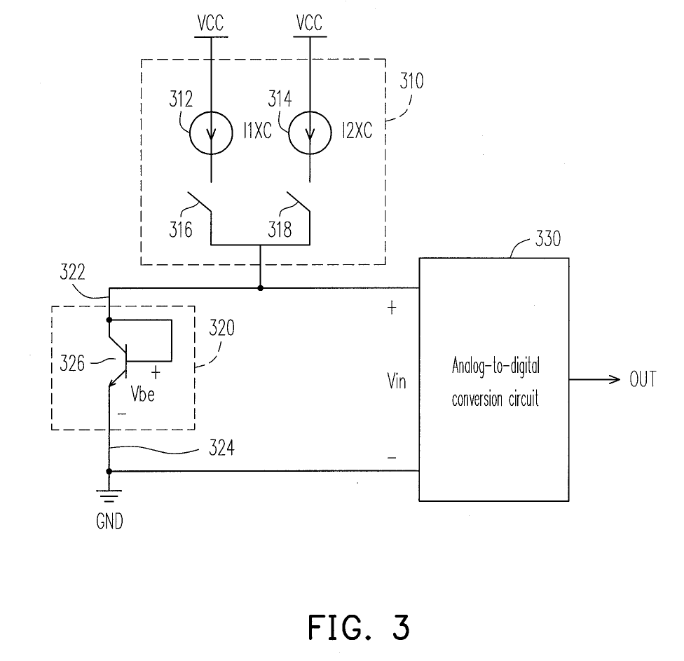

FIG. 3 shows a temperature measuring apparatus according to an embodiment of the present invention. Referring to FIG. 3, the temperature measuring apparatus includes a current supply circuit 310, a temperature measuring device 320, and an analog-to-digital conversion circuit 330. The temperature measuring device 320 has a first end 322 and a second end 324. Functions of the current supply circuit 310 and the analog-to-digital conversion circuit 330 are briefly described in the following.

The current supply circuit 310 is coupled to the first end 322 of the temperature measuring device 320 to provide a first current, a second current, a third current and a fourth current to the temperature measuring device 320 respectively. Intensities of the currents differ from one another, and a ratio of the first current to the second current is equal to a ratio of the third current to the fourth current. The analog-to-digital conversion circuit 330 is coupled to the first end 322 and the second end 324 of the temperature measuring device 320 for obtaining correspondingly a first voltage, a second voltage, a third voltage and a fourth voltage at the two ends of the temperature measuring device 320 when the current supply circuit 310 provides the first current, the second current, the third current and the fourth current respectively. The analog-to-digital conversion circuit 330 also obtains a first voltage variation value according to the first voltage and the second voltage, and obtains a second voltage variation value according to the third voltage and the fourth voltage. Moreover, the analog-to-digital conversion circuit 330 converts the first voltage variation value into a first digital temperature code representing a first temperature, converts the second variation value into a second digital temperature code representing a second temperature, and obtains a real temperature code corresponding to a real temperature according to the first digital temperature code and the second digital temperature code. The real temperature code serves as a temperature data OUT outputted by the temperature measuring device 320.

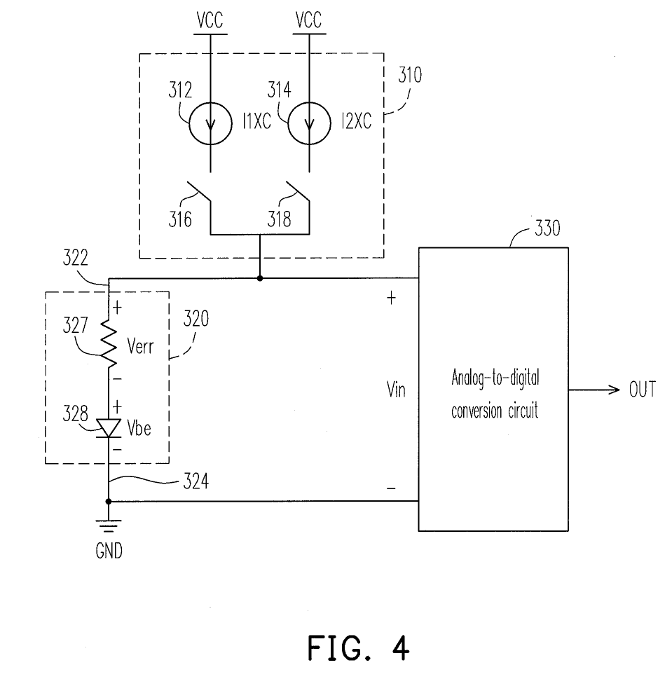

According to the present embodiment, the current supply circuit 310 is implemented by current sources 312 and 314 and switches 316 and 318. Each of the current sources 312 and 314 has an end coupled to a supply voltage VCC. In addition, the temperature measuring device 320 is implemented by an NPN-type transistor 326, and a collector of the transistor 326 is used as the first end 322 of the temperature measuring device 320, and an emitter of the transistor 326 is used as the second end 324 of the temperature measuring device 320 and coupled to a ground voltage GND. A base of the transistor 326 is coupled to the collector thereof. To facilitate explanation, the equivalent circuit of FIG. 3 is taken for example, as shown by FIG. 4.

Referring to FIG. 4, in FIG. 4 the transistor 326 of FIG. 3 is rendered equivalent to a resistance 327 and a diode 328. The diode 328 represents an equivalent diode constituted by a PN junction of a base-emitter of the transistor 326. The resistance 327 represents a parasitic serial resistance inside the transistor 326. In operation of the temperature measuring apparatus, first, a multiple C shown by FIG. 4 is designated as a first multiple C1. The first multiple C1 is larger than zero, and the switch 318 is solely turned on to provide a first current value I2 of C1 times (i.e., the first current) to the temperature measuring device 320 so that the analog-to-digital conversion circuit 330 obtains a voltage Vin (i.e., the first voltage). A value of the voltage Vin is expressed as a following formula (1):

$$\begin{matrix}Vin ( C 1 \times I 2 ) = Vbe + Verr \\ = ( η kT / q ) \times ln ( C 1 \times I 2 / Is ) + ( C 1 \times I 2 \times Rs )\end{matrix} \qquad ( 1 )$$

η represents an ideality factor of the PN junction; k represents a Boltzman's constant; T represents an absolute temperature; q represents quantity of electronic charge; Is represents a saturation current of the diode 328, and Rs represents a value of the resistance 327.

Thereafter, a multiple C shown by FIG. 4 is also designated as the first multiple C1 and the switch 316 is solely turned on to provide a second current value I1 of C1 times (i.e., the second current) to the temperature measuring device 320. The second current value I1 is smaller than the first current value I2. Thus, the analog-to-digital conversion circuit 330 further obtains another voltage Vin (i.e., the second voltage). A value of the second voltage is expressed as a following formula (2):

Vin(C1×I1)×ln(C1×I1/Is)+(C1×I1×Rs) (2)

Then, the analog-to-digital conversion circuit 330 subtracts Vin(C1×I1) from Vin(C1×I2), i.e., Formula (1) minus Formula (2), to obtain a first voltage variation value of the voltage Vin. The first voltage variation value is expressed by a following formula (3):

$$\begin{matrix}Δ Vin ( i ) = Vin ( C 1 \times I 2 ) - Vin ( C 1 \times I 1 ) \\ = ( η kT / q ) \times ln ( I2 / I 1 ) + C 1 ( I 2 - I 1 ) Rs\end{matrix} \qquad ( 3 )$$

Certainly, the analog-to-digital conversion circuit 330 may also employ a method expressed by |Vin(C1×I1)−Vin(C1×I2)| to obtain the first voltage variation value ΔVin(i). Therefore, the present invention is not limited to obtaining the first voltage variation value ΔVin(i) by subtracting Vin(C1×I1) from Vin(C1×I2). Still referring to FIG. 4, afterwards, the analog-to-digital conversion circuit 330 further converts ΔVin(i) into a first digital temperature code representing a first temperature. According to the present embodiment, the analog-to-digital conversion circuit 330 employs a method expressed by a following formula (4) to convert ΔVin(i):

Voltage variation value=K×Temperature (4)

K is a conversion rate of the voltage variation value to temperature of the analog-to-digital conversion circuit 330.

After obtaining the first digital temperature code, the multiple C shown by FIG. 4 is designated as a second multiple C2. The second multiple C2 is likewise larger than zero and not equal to the first multiple C1. At the same time, the switch 318 is solely turned on to provide the first current value I2 (i.e., the third current) of C2 times to the temperature measuring device 320 so that the analog-to-digital conversion circuit 330 further obtains a voltage Vin (i.e., the third voltage). A value of the third voltage Vin is expressed as a following formula (5):

Vin(C2×I1)=(ηkT/q)×ln(C2×I1/Is)+(C2×I1×Rs) (5)

Then, the multiple C shown by FIG. 4 is likewise designated as the second multiple C2, and the switch 316 is solely turned on to provide the second current value I1 (i.e., the fourth current) to the temperature measuring device 320 so that the analog-to-digital conversion circuit 330 further obtains a voltage Vin. A value of the voltage Vin is expressed as a following formula (6):

Vin(C2×I1)=(ηkT/q)×ln(C2×I1/Is)+(C2×I1×Rs) (6)

Then, the analog-to-digital conversion circuit 330 subtracts Vin(C2×I1) from Vin(C2×I2), i.e., Formula (5) minus Formula (6), to obtain a second voltage variation value of the voltage Vin. The second voltage variation value is expressed by a following formula (7):

$$\begin{matrix}Δ Vin ( ii ) = Vin ( C 2 \times I 2 ) - Vin ( C 2 \times I 1 ) \\ = ( η kT / q ) \times ln ( I 2 / I 1 ) + C 2 ( I 2 - I 1 ) Rs\end{matrix} \qquad ( 7 )$$

Afterwards, the analog-to-digital conversion circuit 330 further employs a method expressed by Formula (4) to convert ΔVin(ii) into a second digital temperature code representing a second temperature.

Next, according to the present embodiment, a description as to how the analog-to-digital conversion circuit 330 obtains a real temperature code corresponding to the real temperature according to the first digital temperature code and the second digital temperature code is provided below. First, suppose that ΔVin is an ideality voltage variation value not affected by Rs, ΔVin may be expressed by a following formula (8):

$$\begin{matrix}Δ Vin = ( η kT / q ) \times ln ( I 2 / I 1 ) \\ = Δ Vin ( i ) - C 1 ( I 2 - I 1 ) Rs \\ = Δ Vin ( i ) - C 1 ( I 2 - I 1 ) Rs \times ( C 2 - C 1 ) / ( C 2 - C 1 )\end{matrix} \qquad ( 8 )$$

Subtracting ΔVin(i) from ΔVin(ii) may be expressed by a following formula (9):

$$\begin{matrix}Δ Vin ( iii ) = Δ Vin ( ii ) - Δ Vin ( i ) \\ = ( ( η kT / q ) \times ln ( I 2 / I 1 ) + C 2 ( I 2 - I 1 ) Rs ) - \\ ( ( η kT / q ) \times ln ( I 2 / I 1 ) + C 1 ( I 2 - I 1 ) Rs ) \\ = ( C 2 - C 1 ) ( I 2 - I 1 ) Rs\end{matrix} \qquad ( 9 )$$

Therefore, Formula (8) may be rewritten as a following formula (10) according to Formula (9):

ΔVin=ΔVin(i)−ΔVin(iii)×C1/(C2−C1) (10)

Additionally, since the analog-to-digital conversion circuit 330 converts by a method expressed by Formula (4), it is known that relationships among ΔVin,ΔVin(i),ΔVin(ii) and ΔVin(iii) with respect to K and the temperature in Formula (4) are as follows:

ΔVin=K×T (11)

ΔVin(i)=K×T1 (12)

ΔVin(ii)=K×T2 (13)

ΔVin(iii)=K×(T2−T1) (14)

T is the real temperature; T1 is the first temperature, and T2 is the second temperature. Hence, Formulas (11), (12) and (14) may be employed to rewrite Formula (10) as a following formula (15):

$$\begin{matrix}K \times T = K \times T 1 - K \times ( T 2 - T 1 ) \times C 1 / ( C 2 - C 1 ) \\ = K \times ( C 2 \times T 1 - C 1 \times T 2 ) / ( C 2 - C 1 )\end{matrix} \qquad ( 15 )$$

It is known from Formula (15) that T may be expressed by a following formula (16):

T=(2×T1−C1×T2)/(C2−C1) (16)

Formula (16) is a relationship formula among T, T1 and T2. In other words, Formula (16) is the relationship formula among the real temperature, the first temperature and the second temperature. Accordingly, the analog-to-digital conversion circuit 330 may employ the temperature formula to obtain the real temperature code corresponding to the real temperature according to the first digital temperature code and the second digital temperature code.

It is noted that according to the present embodiment, a ratio of the first current value I1 to the second current value I2 needs to be fixed, and a current mirror and its principle may be employed to implement this technique.

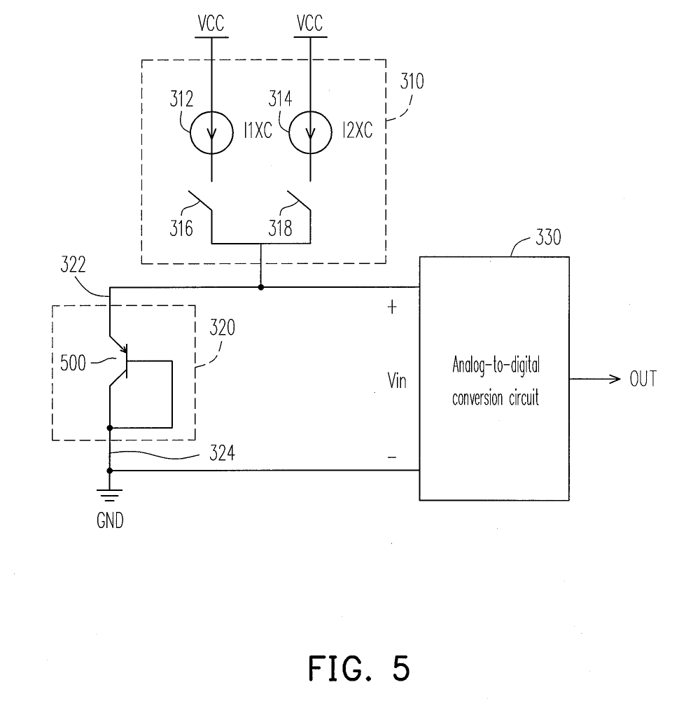

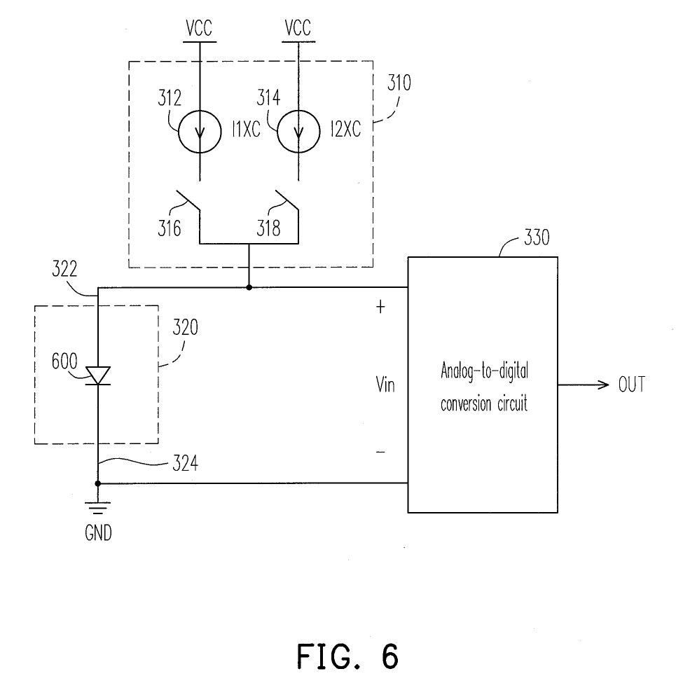

Although according to the foregoing embodiment, the temperature measuring device 320 is implemented by an NPN-type transistor 326, one of ordinary skill in the art should know that a PNP-type transistor, a general diode or other devices having a PN junction may all be employed as the temperature measuring device 320 to implement the present invention. FIG. 5 shows a temperature measuring apparatus according to another embodiment of the present invention. FIG. 5 mainly illustrates a PNP-type transistor (as indicated by numeral 500) in replacement of an NPN-type transistor. FIG. 6 shows a temperature measuring apparatus according to another embodiment of the present invention. FIG. 6 mainly illustrates a general diode (as indicated by numeral 600) in replacement of an NPN-type transistor. Since the operation of the apparatuses shown by FIGS. 5 and 6 is very similar to that of the apparatus shown by FIG. 3, details of the operation are omitted here.

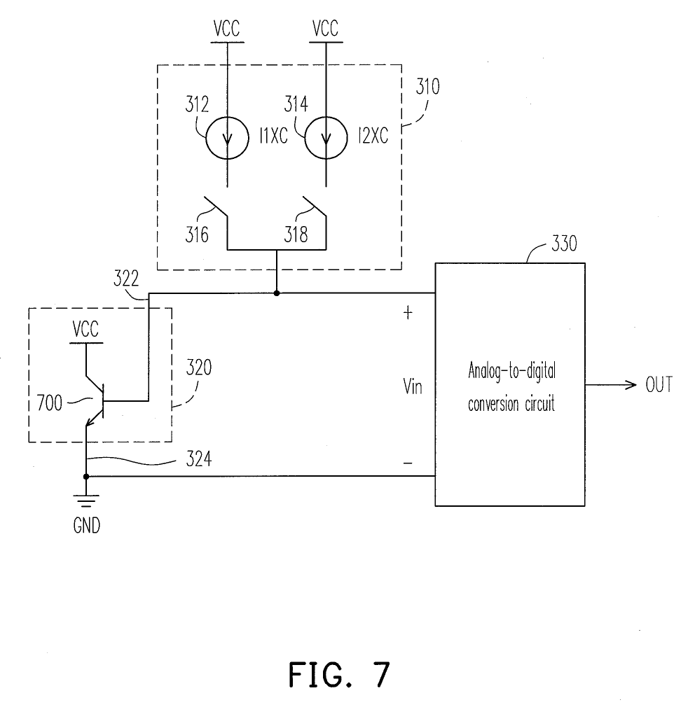

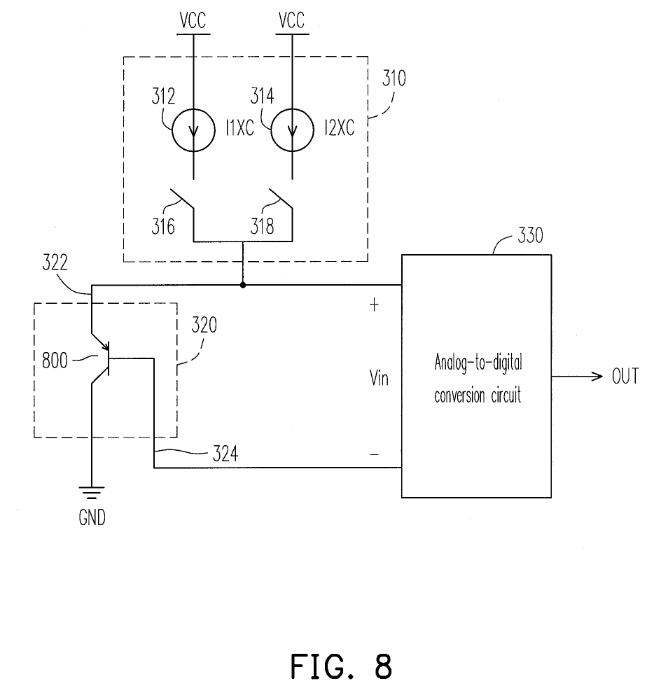

Additionally, in FIGS. 3 and 5, the transistors employed to implement the temperature measuring device 320 are diode connected. However, the present invention is not limited to diode connection to obtain the voltage Vin. In fact, no matter how the transistors are coupled, as long as the voltage Vin and a base-emitter voltage Vbe of the transistors are connected, the connection would work, as shown by FIGS. 7 and 8. FIG. 7 shows a temperature measuring apparatus according to another embodiment of the present invention. FIG. 7 mainly illustrates an NPN-type transistor 700 not diode connected. FIG. 8 shows a temperature measuring apparatus according to yet another embodiment of the present invention. FIG. 8 mainly illustrates a PNP-type transistor 800 not diode connected.

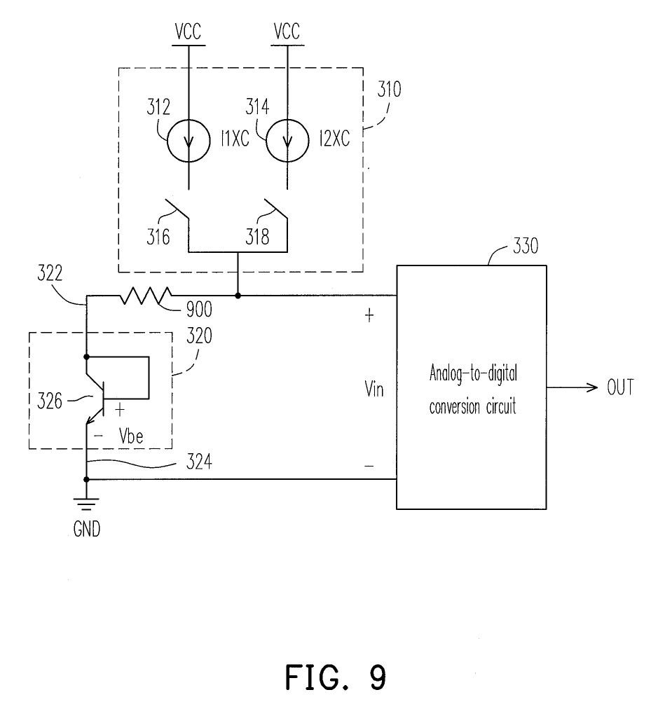

It is to be noted that in a situation of real temperature measuring a position of the temperature measuring device 320 may be in a distance from the analog-to-digital conversion circuit 330, and the distance may generate other resistances, as shown by FIG. 9. FIG. 9 shows the circuit in FIG. 3 having the situation. A resistance 900 in FIG. 9 is generated under such circumstances because a connecting line between the temperature measuring device 320 and the analog-to-digital conversion circuit 330 is too long. The resistance 900 is serially connected to the temperature measuring device 320. Although occurrence of the resistance 900 is sometimes inevitable, since the resistance 900 may be added to the parasitic serial resistance and both rendered as another resistance, the temperature measuring in the present invention would not be affected. Certainly, the same situation also occurs to the circuits shown in FIGS. 5 through 8. Relevant details are thus not repeated here. In addition, if the resistance 900 of FIG. 9 is a real resistance added by a user, it can be know from the above description that this arrangement still does not affect the temperature measuring in the present invention.

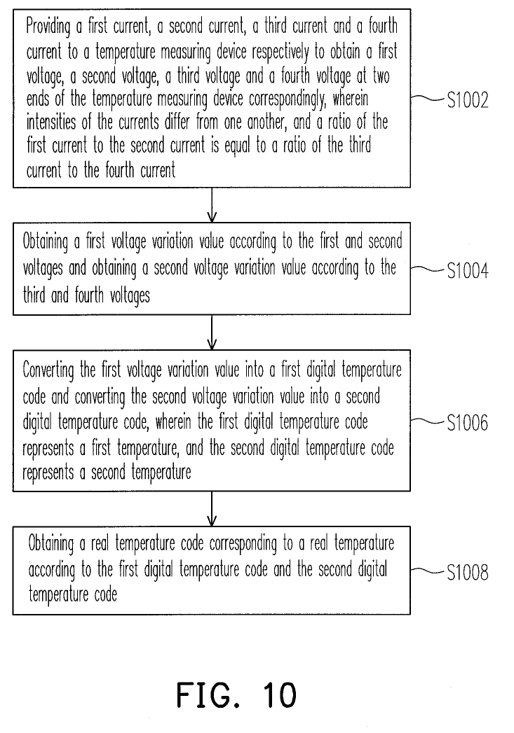

Through the teachings of the foregoing embodiment, a flowchart of the temperature measuring method is generalized, as shown by FIG. 10. The temperature measuring method includes following steps. First, a first current, a second current, a third current and a fourth current are provided to a temperature measuring device respectively to obtain a first voltage, a second voltage, a third voltage and a fourth voltage at two ends of the temperature measuring device correspondingly. Intensities of the currents differ from one another, and a ratio of the first current to the second current is equal to a ratio of the third current to the fourth current, as shown by a step S1002. Afterwards, a first voltage variation value is obtained according to the first voltage and the second voltage, and a second voltage variation value is obtained according to the third voltage and the fourth voltage, as shown by a step S1004. Thereafter, the first voltage variation value is converted into a first digital temperature code, and the second voltage variation value is converted into a second digital temperature code. The first digital temperature code represents a first temperature, and the second digital temperature code represents a second temperature, as shown by a step S1006. Then, a real temperature code corresponding to a real temperature is obtained according to the first digital temperature code and the second digital temperature code, as shown by a step S1008.

In summary, the present invention provides four different currents to a temperature measuring device respectively to obtain four different voltages at the two ends of the temperature measuring device correspondingly. Among the four currents, the ratio of two of the four currents is equal to the ratio of the other two currents. Next, two voltage variation values are obtained according to the two current sets with the same ratio and the four voltages, and the two voltage variation values are converted into the first digital temperature code and the second digital temperature code respectively. The first digital temperature code represents the first temperature, and the second digital temperature code represents the second temperature. Then, the real temperature code corresponding to the real temperature is obtained according to the first digital temperature code and the second digital temperature code. After obtaining the two voltage variation values, the two voltage variation values are converted into the first digital temperature code and the second digital temperature code respectively. Therefore, even if the voltage variation values need to be amplified to be converted into the digital temperature codes, the voltage variation values may appear greater by adjusting the current ratio can beforehand. The voltage variation values no longer require a larger amplifying power to amplify the voltage variation values and thereby restraining errors in temperature measuring.

Furthermore, as long as the temperature measuring device has an equivalent diode and a parasitic serial resistance, and the equivalent diode and the parasitic serial resistance are serially connected between the first end and the second end of the temperature measuring device, the temperature formula expressed as T=(C2×T1−C1×T2)/(C2−C1) may be employed to obtain the real temperature code corresponding to the real temperature.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A temperature measuring method, comprising: providing a first current, a second current, a third current and a fourth current to a temperature measuring device respectively to obtain a first voltage, a second voltage, a third voltage and a fourth voltage at two ends of the temperature measuring device correspondingly, wherein intensities of the currents differ from one another, and a ratio of the first current to the second current is equal to a ratio of the third current to the fourth current;
obtaining a first voltage variation value according to the first voltage and the second voltage and obtaining a second voltage variation value according to the third voltage and the fourth voltage;
converting the first voltage variation value into a first digital temperature code and converting the second voltage variation value into a second digital temperature code, wherein the first digital temperature code represents a first temperature, and the second digital temperature code represents a second temperature; and
obtaining a real temperature code corresponding to a real temperature according to the first digital temperature code and the second digital temperature code.

2. The temperature measuring method as claimed in claim 1, wherein the intensity of the first current is a first current value of a first multiple, the intensity of the second current is a second current value of the first multiple, the intensity of the third current is the first current value of a second multiple, and the intensity of the fourth current is the second current value of the second multiple, wherein the first current value is larger than the second current value, the first multiple not equal to the second multiple, both the first multiple and the second multiple being larger than zero.

3. The temperature measuring method as claimed in claim 2, wherein a temperature formula is employed to obtain the real temperature code, and the temperature formula is expressed as:
T=(C2×T1−C1×T2)/(C2−C1)
wherein T represents the real temperature, C2 represents the second multiple, T1 represents the first temperature, C1 represents the first multiple, and T2 represents the second temperature.

4. The temperature measuring method as claimed in claim 1, wherein the second voltage is subtracted from the first voltage to obtain the first voltage variation value.

5. The temperature measuring method as claimed in claim 1, wherein the fourth voltage is subtracted from the third voltage to obtain the second voltage variation value.

6. A temperature measuring apparatus, comprising:
a temperature measuring device, having a first end and a second end;
a current supply circuit, coupled to the first end of the temperature measuring device for providing a first current, a second current, a third current and a fourth current to the temperature measuring device respectively, wherein intensities of the currents differ from one another, and a ratio of the first current to the second current is equal to a ratio of the third current to the fourth current; and
an analog-to-digital conversion circuit, coupled to the first end and the second end of the temperature measuring device for obtaining correspondingly a first voltage, a second voltage, a third voltage and a fourth voltage at two ends of the temperature measuring device when the current supply circuit provides the first current, the second current, the third current and the fourth current; obtaining a first voltage variation value according to the first voltage and the second voltage and obtaining a second voltage variation value according to the third voltage and the fourth voltage; converting the first voltage variation value into a first digital temperature code representing a first temperature and converting the second variation value into a second digital temperature code representing a second temperature; and obtaining a real temperature code corresponding to a real temperature according to the first digital temperature code and the second digital temperature code.

7. The temperature measuring apparatus as claimed in claim 6, wherein the intensity of the first current is a first current value of a first multiple, the intensity of the second current is a second current value of the first multiple, the intensity of the third current is the first current value of a second multiple, and the intensity of the fourth current is the second current value of the second multiple, wherein the first current value is larger than the second current value, the first multiple not equal to the second multiple, both the first multiple and the second multiple being larger than zero.

8. The temperature measuring apparatus as claimed in claim 7, wherein the temperature measuring device has an equivalent diode constituted by a PN junction and a parasitic serial resistance serially connected to the equivalent diode, the equivalent diode and the parasitic serial resistance being serially connected between the first end and the second end.

9. The temperature measuring apparatus as claimed in claim 8, further comprising a resistance serially connected to the temperature measuring device.

10. The temperature measuring apparatus as claimed in claim 9, wherein the resistance comprises a resistance of a connecting line between the temperature measuring device and the analog-to-digital conversion circuit.

11. The temperature measuring apparatus as claimed in claim 8, wherein the analog-to-digital conversion circuit employs a temperature formula to obtain the real temperature code, and the temperature formula is expressed as:
T=(C2×T1−C1×T2)/(C2−C1)
wherein T represents the real temperature, C2 represents the second multiple, T1 represents the first temperature, C1 represents the first multiple, and T2 represents the second temperature.

12. The temperature measuring apparatus as claimed in claim 6, wherein the analog-to-digital conversion circuit subtracts the second voltage from the first voltage to obtain the first voltage variation value.

13. The temperature measuring apparatus as claimed in claim 6, wherein the analog-to-digital conversion circuit subtracts the fourth voltage from the third voltage to obtain the second voltage variation value.
